(19) United States
(12) Patent Application Publication
(10) Pub. No.: US 2011/0116281 A1
(43) Pub. Date: May 19, 2011

(54) VEHICLE LAMP

(75) Inventors: Yuuji KUROIWA, Shizuoka (JP); Koji ANDO, Shizuoka (JP); Tomoaki NAKANO, Shizuoka (JP)

(73) Assignee: KOITO MANUFACTURING CO., LTD., Tokyo (JP)

(21) Appl. No.: 12/944,934

(22) Filed: Nov. 12, 2010

(30) Foreign Application Priority Data
Nov. 16, 2009 (JP) 2009-261238

(51) Int. Cl. B60Q 1/00

(52) U.S. Cl. 362/548

(57) ABSTRACT

A vehicle lamp includes a housing, a transparent outer cover attached to the housing to form a lamp chamber together with the housing, a lamp unit disposed inside the lamp chamber to send light toward an outside of the lamp chamber through the outer cover, a sealing member arranged to seal a space between the housing and the outer cover, and an adhesive member disposed inside the lamp chamber in an at least partially exposed manner.

### CROSS-REFERENCE TO RELATED APPLICATIONS

The present application claims priority from Japanese Patent Application No. 2009-261238 filed on Nov. 16, 2009, the entire content of which is incorporated herein by reference.

### FIELD OF INVENTION

The present invention relates to a vehicle lamp having a lamp unit disposed inside a lamp chamber formed by a housing and an outer cover.

### DESCRIPTION OF RELATED ART

A vehicle lamp generally includes a housing, an outer cover and a lamp unit. The housing is formed to have a box-like shape having an opening on one side, and the outer cover is attached to cover the opening of the housing. The lamp unit is disposed inside a lamp chamber which is formed by the housing and the outer cover. The outer cover is transparent so that the interior of the lamp chamber is visible from the outside. Therefore, with a view to keeping a good aesthetic condition of the interior of the lamp chamber, a gap between the housing and the outer cover of a related art vehicle lamp is filled with a seal material to prevent foreign particles from entering the lamp chamber (see, e.g., JP 2000-90724 A).

However, it is not only the foreign particles that contaminate the interior of the lamp chamber. For example, a reflecting member such as a reflector of the lamp unit is generally deposited with aluminum or silver, and thus deposition residues may scatter inside the lamp chamber due to a vehicle vibration. Further, the lamp unit generally includes mechanical fastening parts such as a bolt and a nut as well as other metal parts. Thus, burrs of such parts of the lamp unit may chip off and also scatter inside the lamp chamber due to a vehicle vibration. Therefore, such internally-generated particles may also contaminate the interior of the lamp chamber.

### BRIEF SUMMARY

Illustrative aspects of the invention provide a vehicle lamp configured to prevent contamination of an interior of a lamp chamber.

According to an illustrative aspect of the invention, a vehicle lamp includes a housing, a transparent outer cover attached to the housing to form a lamp chamber together with the housing, a lamp unit disposed inside the lamp chamber to send light toward an outside of the lamp chamber through the outer cover, a sealing member arranged to seal a space between the housing and the outer cover, and an adhesive member disposed inside the lamp chamber at least partially in an exposed manner.

Other aspects and advantages of the invention will be apparent from the following description, the drawings and the claims.

### BRIEF DESCRIPTION OF THE DRAWINGS

FIG. 1 is a vertical sectional view of a vehicle lamp according to an exemplary embodiment of the invention; and

FIG. 2 is a front view of the vehicle lamp.

### DETAILED DESCRIPTION

Hereinafter, an exemplary embodiment of the present invention will be described in detail. However, the following exemplary embodiment does not limit the scope of the claimed invention, and all combinations of features of the exemplary embodiment are not necessarily required to address the problem described above.

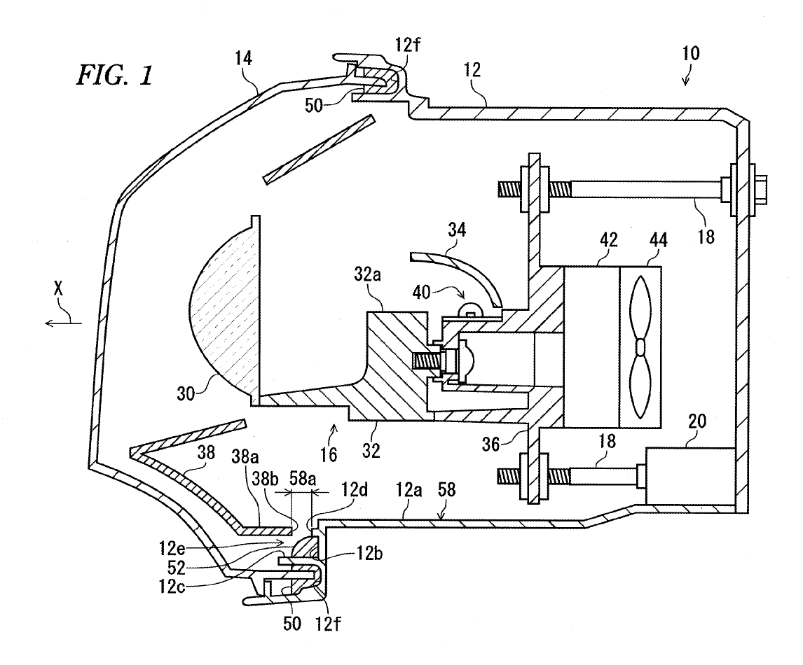

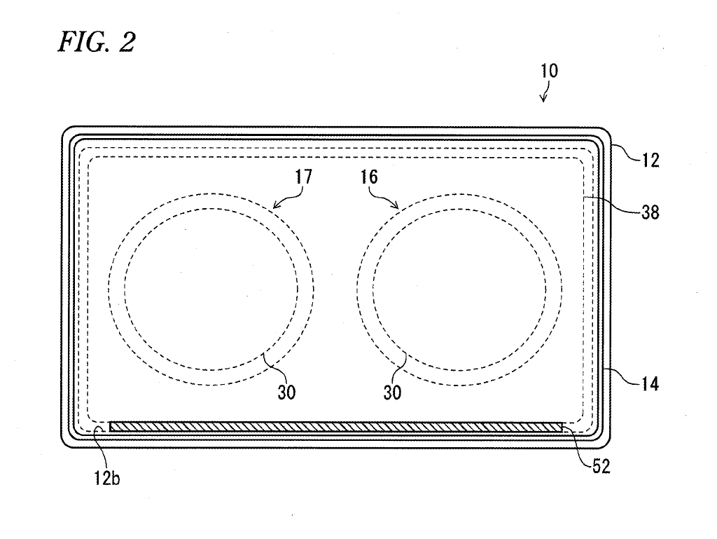

As illustrated in FIGS. 1 and 2, a vehicle lamp 10 according to the exemplary embodiment includes a housing 12, an outer cover 14, lamp units 16, 17, and an extension 38. The vehicle lamp 10 is configured as a headlamp which is mounted on each side of a front portion of a vehicle so that the lamp 10 is oriented in a forward direction X shown in FIG. 1. Right and left headlamps are symmetrically configured. Therefore, only one of the headlamps will be described below. FIG. 1 is a sectional view of the headlamp 10 taken along a vertical plane including the optical axis of the lamp unit 16.

The housing 12 is formed to have a box-like shape having a front opening. The outer cover 14 is made of transparent resin or glass, and has a bowl shape. The edge portion of the outer cover 14 is attached to the housing 12 to cover the opening of the housing 12, whereby a lamp chamber is formed as a region enclosed by the housing 12 and the outer cover 14.

The lamp units 16, 17 and the extension 38 are disposed inside the lamp chamber. The lamp units 16, 17 are both arranged such that irradiate a region in front of the headlamp 10. More specifically, the lamp unit 16 produces a low beam and the lamp unit 17 produces a high beam. The lamp unit 17 may be configured in a similar manner as the lamp unit 16 except that a reflector and other components of the lamp unit 17 are configured and arranged to form a high beam light distribution pattern. Therefore, only the lamp unit 16 will be described in detail below, and description of the lamp unit 17 will be omitted.

The lamp unit 16 is attached to the housing 12 via aiming screws 18. The lower aiming screw 18 is configured such that it is rotated when a leveling actuator 20 is operated. That is, the optical axis of the lamp unit 16 can be moved in up and down directions by operating the leveling actuator 20.

The lamp unit 16 includes a projection lens 30, a support member 32, a reflector 34, a bracket 36, a light emitting module 40, heat dissipating fins 42, and a cooling fan 44. The projection lens 30 is a plano-convex aspherical lens having a convex front surface and a flat rear surface. The projection lens 30 projects a light source image formed on the rear focal plane thereof toward the front of the headlamp 10 as an inverted image. The support member 32 supports the projection lens 30.

The light emitting module 40 includes a semiconductor light emitting device. According to the exemplary embodiment, the semiconductor light emitting device is a white light emitting diode (LED). However, the semiconductor light emitting device may be a laser diode. Further, the light emitting module 40 may not necessarily include a semiconductor light emitting device. For example, the light emitting module 40 may include an incandescent lamp with a filament or a discharge lamp.

The reflector 34 reflects light from the light emitting module 40 to form the light source image on the rear focal plane of the projection lens 30. Accordingly, the reflector 34 has a reflecting surface formed by mirror treatment such as aluminum deposition. As described above, the reflector 34 and the projection lens 30 function as optical components that collect and forwardly project the light emitted from the light emitting module 40. The heat dissipating fins 42 are arranged on a rear surface of the bracket 36 to dissipate heat generated primarily by the light emitting module 40. The cooling fan 44 is attached to the heat dissipating fins 42, and sends air toward the heat dissipating fins 42 to enhance the heat dissipation from the heat dissipating fin 42.

The support member 32 includes a shade 32a. The shade 32a shields a part of the light emitted from the light emitting module 40 and reflected by the reflector 34 so as to form a cutoff line of a low beam light distribution pattern ahead of the vehicle. The low beam light distribution pattern is well known and thus description thereof is omitted here. The extension 38 is provided so as to surround the projection lens 30. The outer surface of the extension 38 is subjected to a mirror treatment such as aluminum deposition, and functions as a design surface that is visible from the outside.

The housing 12 has a groove portion 12f along an opening edge of the housing 12. The groove portion 12f is formed such that it is opened toward the front of the headlamp 10, and a sealing member 50 fitted therein. The edge portion of the outer cover 14 is inserted into the groove portion 12f in which the sealing member 50 has been provided. In this manner, the sealing member 50 seals up a space between the housing 12 and the outer cover 14.

The sealing member 50 is made of a hot-melt adhesive. The hot-melt adhesive is a sealing material which melts when heated, but does not become completely solidified after being cooled. According to the exemplary embodiment, the hot-melt adhesive has viscosity in a range of about 10 Pa·S to 70 Pa·S and a viscosity variation rate of about 20% or lower.

More specifically, the sealing member 50 is a gelled hot-melt adhesive. The hot-melt adhesive includes a styrene thermoplastic elastomer (SEBS), butyl rubber or the like as a base polymer and additives including a tackifier made of resin or the like, a wax made of a polypropylene or the like, an anti-oxidizing agent, a pigment, and a plasticizing agent made of a low molecular polymer or the like.

To provide the sealing member 50, a molten hot-melt adhesive may be automatically supplied into the groove portion 12f of the housing 12 using an automatic supply apparatus. The housing 12 with the hot-melt adhesive filled in the groove portion 12f is then cooled until the hot-melt adhesive is gelled. Next, the edge portion of the opening of the outer cover 14 is inserted into the groove portion 12f of the housing 12, and the outer cover 14 is attached to the housing 12.

As described above, the reflecting surface of the reflector 34 and the extension 38 are mirror treated by aluminum deposition or the like. Such vapor deposition processed components may scatter deposition residues inside the lamp chamber due to a vibration of the vehicle or the like. Further, inside the lamp chamber, there are mechanical fastening parts such as a bolt and a nut, and other metal parts. Such mechanical parts may also scatter particles such as chipped off burrs inside the lamp chamber. When such particles stick onto, for example, the design surface of the extension 38, the soiled surface is visible from the outside, which leads to deterioration of an aesthetic aspect of the headlamp 10.

In order to address this problem, the headlamp 10 according to the exemplary embodiment includes an adhesive member 52 arranged inside the lamp chamber. The adhesive member 52 has an adherence property that catches the internally-generated particles describes above so that the particles adhere to the adhesive member 52. The adhesive member 52 is made of the same material as the sealing member 50. Therefore, the adhesive member 52 can be provided on the inner surface of the lamp chamber during the process of automatically filling the groove portion 12f with the hot-met adhesive for the sealing member 50.

More specifically, an additional teaching may be input to a robot (i.e., the automatic supply apparatus), to fill a recessed portion 12e of the housing 12 with the hot-met adhesive to provide the adhesive member 52 in the same process as filling the groove portion 12f with the hot-met adhesive for the sealing member 50. According to this method, the adhesive member 52 can be provided productively with low cost.

The adhesive member 52 is arranged on a portion of the inner surface of the housing 12 adjacent to the groove portion 12f. According to this structure, a wall of the groove portion 12f configured to receive the sealing member 50 can be used to restrict an area in which the hot-melt adhesive for the adhesive member 52 is provided. The housing 12 further includes a rib 12d adjacent to the portion of the inner surface where the adhesive member 52 is arranged. The rib 12d is arranged to extend substantially parallel to a direction along which the groove portion 12f extends. Owing to this, even when the headlamp is turned upside down for example during the manufacturing process or the delivering process, the adhesive member 52 is blocked from moving. Accordingly, the design surface is prevented from being soiled by the adhesive member 52.

More specifically, the inner surface of the housing 12 includes a bottom portion 12a and a vertical surface 12b vertically extending down from the front end of the bottom portion 12a. The housing 12 further includes a horizontal surface 12c arranged to horizontally extend toward the front from the lower end of the vertical surface 12b. The horizontal surface 12c forms a part of the wall that defines the groove portion 12f. The rib 12b is provided protrude toward the front from the vertical surface 12b. The recessed portion 12e, which is opened toward the front, is defined by the rib 12b, the vertical surface 12b and the horizontal surface 12c. The adhesive member 52 is provided in this recessed portion 12e. That is, the rib 12d provides the recessed portion 12e to easily and reliably arrange the adhesive member 52.

The rib 12d extends from a region below the lamp unit 16 to a region below the lamp unit 17. Therefore, as shown in FIG. 2, the adhesive member 52 is arranged to extend in a substantially entire region below the lamp units 16, 17 along the width direction of the lamp units 16, 17. However, the adhesive member 52 may not necessarily be provided in this manner, and may be partially arranged in a region below the lamp unit 16 or the lamp unit 17.

As shown in FIG. 1, the groove portion 12f and the recessed portion 12e are both opened toward the front of the headlamp 10. Therefore, during the process for filling the groove portion 12f with the hot-melt adhesive for the sealing member 50, the hot-melt adhesive for the adhesive member 52 can be easily and reliably provided in the recessed portion 12e.

The bottom portion 38a of the extension 38 is formed on substantially the same level as the bottom portion 12a of the housing 12. The bottom portion 38a of the extension 38 and the bottom portion 12a of the housing 12 form a receiving surface 58 which extends substantially in the horizontal direction in a region below the lamp unit 16. The rear end 38b of the extension 38 is spaced slightly away from the front end of the rib 12b. In other words, the receiving surface 58 is formed with a gap 58a which penetrates the receiving surface 58 in the vertical direction. The adhesive member 52 is arranged directly below the gap 58a.

The internally-generated particles described above drops onto the receiving surface 58 from, for example, the lamp unit 16. Because the gap 58a is formed in the receiving surface 58 and the adhesive member 52 is arranged directly below the gap 58a, the particles efficiently caught by the adhesive member 52 and adhere to the adhesive member 52. The receiving surface 58 may be provided separately from the housing 12 and the extension 38. In this case as well, a gap 58a may also be formed in the receiving surface, and the adhesive member 52 may be disposed directly below the gap.

According to the exemplary embodiment described above, the adhesive member 52 is disposed inside the lamp chamber of the headlamp 10. However, the adhesive member 52 may be disposed inside a lamp chamber of other types of vehicle lamps.

While the present invention has been described with reference to a certain exemplary embodiment thereof, the scope of the present invention is not limited to the exemplary embodiment described above, and it will be understood by those skilled in the art that various changes and modifications may be made therein without departing from the scope of the present invention as defined by the appended claims.

What is claimed is:

1. A vehicle lamp comprising:
a housing;
a transparent outer cover attached to the housing to form a lamp chamber together with the housing;
a lamp unit disposed inside the lamp chamber to send light toward an outside of the lamp chamber through the outer cover;
a sealing member arranged to seal a space between the housing and the outer cover; and
an adhesive member disposed inside the lamp chamber in an at least partially exposed manner.

2. The vehicle lamp according to claim 1, wherein the sealing member and the adhesive member are made of a same material.

3. The vehicle lamp according to claim 1, wherein the housing comprises:
a groove portion in which the sealing member is arranged, and
an inner surface on which the adhesive member is arranged at a portion adjacent to the groove portion.

4. The vehicle lamp according to claim 3, wherein the housing further comprises a rib extending adjacent to the portion of the inner surface where the adhesive member is arranged and substantially parallel to a direction along which the groove portion extends.

5. The vehicle lamp according to claim 3, wherein the groove portion comprises a wall having a first side and a second side opposite the first side,
the sealing member is arranged on the first side and the adhesive member is arranged on the second side.

6. The vehicle lamp according to claim 4, wherein the groove portion comprises a wall having a first side and a second side opposite the first side,
the sealing member is arranged on the first side and the adhesive member is arranged on the second side,
the wall, the rib and the portion of the inner surface of the housing form a recessed portion in which the adhesive member is arranged, and
the groove portion and the recessed portion are both opened in a same direction.

7. The vehicle lamp according to claim 1, wherein the adhesive member is arranged below the lamp unit.

8. The vehicle lamp according to claim 7, further comprising an extension arranged to surround the lamp unit,
wherein a gap is provided between the inner surface of the housing and the extension, and
the adhesive member is arranged directly below the gap.
